(19) United States
(12) Patent Application Publication
(10) Pub. No.: US 2007/0005868 A1
(43) Pub. Date: Jan. 4, 2007

(54) Method, apparatus and system for posted write buffer for memory with unidirectional full duplex interface

(76) Inventor: Randy B. Osborne, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,658

(22) Filed: Jun. 30, 2005

(51) Int. Cl. G06F 13/36

(52) U.S. Cl. 710/310

(57) ABSTRACT

In some embodiments, a method, apparatus and system for posted write buffer for memory with unidirectional full duplex interface are presented. In this regard, a buffer agent is introduced to send data to a posted write buffer and to send an independent indication to the memory to write the data to an address. Other embodiments are also disclosed and claimed.

### FIELD OF THE INVENTION

Embodiments of the present invention generally relate to the field of memory, and, more particularly to a method, apparatus and system for posted write buffer for memory with unidirectional full duplex interface.

### BACKGROUND OF THE INVENTION

As the computing power of processors increases, so does the need for faster data transfers with memory devices. In addition to improving memory bandwidth, it is beneficial to improve the efficiency with which memory bandwidth is utilized.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing a buffer agent, in accordance with one example embodiment of the invention;

FIG. 2 is a block diagram of an example buffer agent architecture, in accordance with one example embodiment of the invention;

FIG. 3 is a flow chart of an example method for posted write buffering, in accordance with one example embodiment of the invention; and

FIG. 4 is a block diagram of an example storage medium comprising content which, when accessed by a device, causes the device to implement one or more aspects of one or more embodiment(s) of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

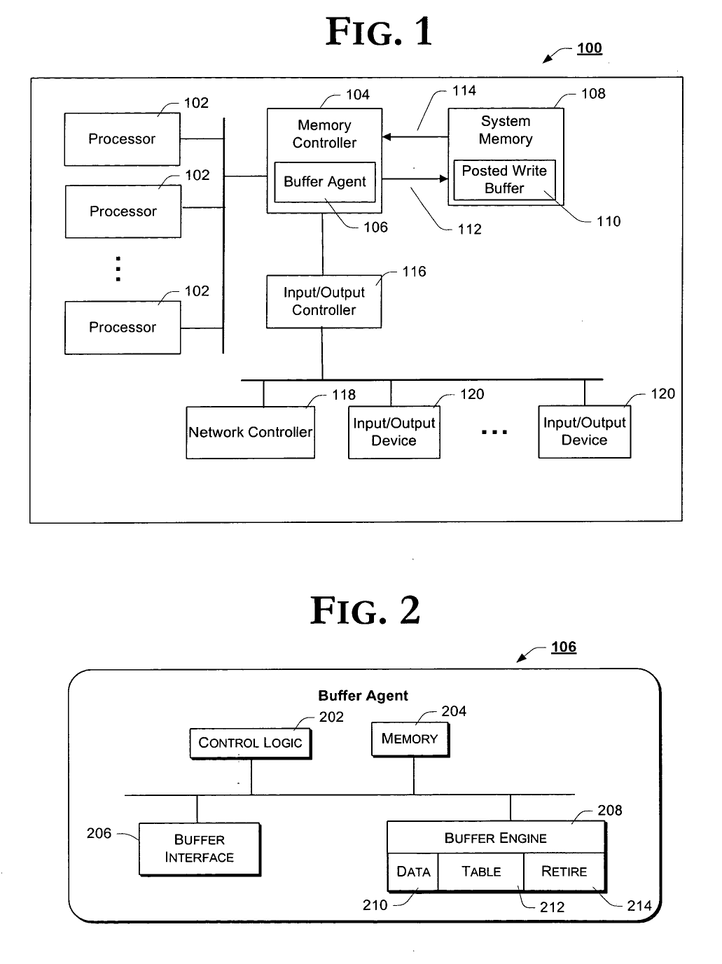

FIG. 1 is a block diagram of an example electronic appliance suitable for implementing a buffer agent, in accordance with one example embodiment of the invention. Electronic appliance 100 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, buffer agent 106, system memory 108, posted write buffer 110, write interface 112, read interface 114, input/output controller 116, network controller 118, and input/output device(s) 120 coupled as shown in FIG. 1. Buffer agent 106, as described more fully hereinafter, may well be used in electronic appliances of greater or lesser complexity than that depicted in FIG. 1. Also, the innovative attributes of buffer agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

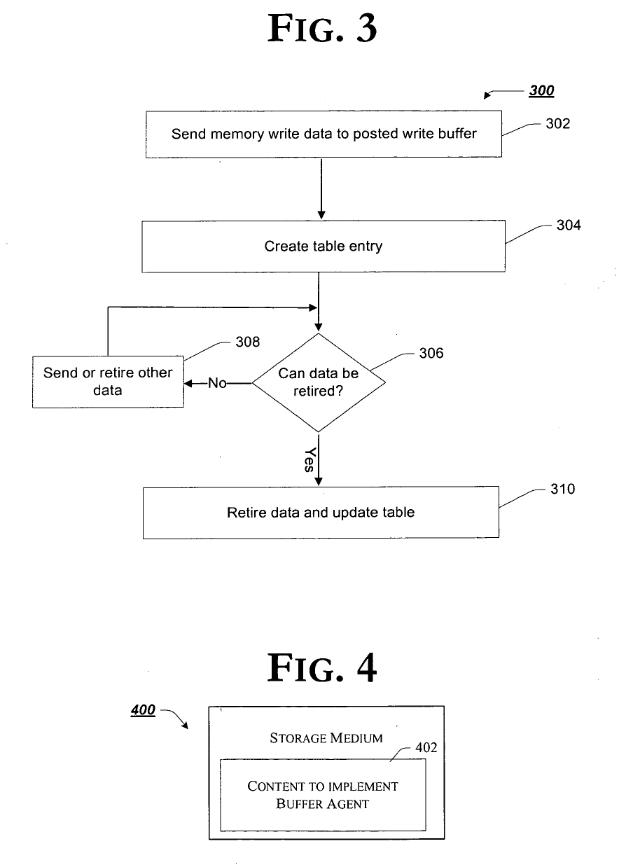

Buffer agent 106 may have an architecture as described in greater detail with reference to FIG. 2. Buffer agent 106 may also perform one or more methods for buffering memory writes, such as the method described in greater detail with reference to FIG. 3. While shown as being part of memory controller 104, buffer agent 106 may well be part of another component, for example processor(s) 102 or input/output controller 116, or may be implemented in software or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM). The present invention, however, is not limited to the examples of memory mentioned here.

Posted write buffer 110 represents a relatively small memory used to temporarily store data before it is retired (written) to its destination address. Posted write buffer 110 may be indexed so that a particular data entry can be retired irrespective of the order in which it was received. In one embodiment, Posted write buffer 110 also stores the address(es) to which the data will eventually be retired. Posted write buffer 110 may contain control logic to, among other things, reset and maintain a buffer pointer, to input data to buffer locations, and to output data to memory devices.

Write interface 112 represents a unidirectional interface through which data and commands are sent to system memory 108. In one embodiment write interface 112 is a serial interface. In another embodiment write interface 112 is a parallel interface.

Read interface 114 represents a unidirectional interface through which data is read from system memory 108. In one embodiment read interface 114 is a serial interface. In another embodiment read interface 114 is a parallel interface.

Input/output (I/O) controller 116 may represent any type of chipset or control logic that interfaces I/O device(s) 120 with the other components of electronic appliance 100. In one embodiment, I/O controller 116 may be referred to as a south bridge. In another embodiment, I/O controller 116 may comply with the Peripheral Component Interconnect (PCI) Express™ Base Specification, Revision 1.0a, PCI Special Interest Group, released Apr. 15, 2003.

Network controller 118 may represent any type of device that allows electronic appliance 100 to communicate with other electronic appliances or devices. In one embodiment, network controller 118 may comply with a The Institute of Electrical and Electronics Engineers, Inc. (IEEE) 802.11b standard (approved Sep. 16, 1999, supplement to ANSI/IEEE Std 802.11, 1999 Edition). In another embodiment, network controller 118 may be an Ethernet network interface card.

Input/output (I/O) device(s) 120 may represent any type of device, peripheral or component that provides input to or processes output from electronic appliance 100.

FIG. 2 is a block diagram of an example buffer agent architecture, in accordance with one example embodiment of the invention. As shown, buffer agent 106 may include one or more of control logic 202, memory 204, controller interface 206, and buffer engine 208 coupled as shown in FIG. 2. In accordance with one aspect of the present invention, to be developed more fully below, buffer agent 106 may include a buffer engine 208 comprising one or more of data services 210, table services 212, and/or retire services 214. It is to be appreciated that, although depicted as a number of disparate functional blocks, one or more of elements 202-214 may well be combined into one or more multi-functional blocks. Similarly, buffer engine 208 may well be practiced with fewer functional blocks, i.e., with only table services 212, without deviating from the spirit and scope of the present invention, and may well be implemented in hardware, software, firmware, or any combination thereof. In this regard, buffer agent 106 in general, and buffer engine 208 in particular, are merely illustrative of one example implementation of one aspect of the present invention. As used herein, buffer agent 106 may well be embodied in hardware, software, firmware and/or any combination thereof.

Buffer agent 106 may have the ability to send data to a posted write buffer, to maintain a table of the data in the posted write buffer, and to retire data from the posted write buffer to a memory address. In one embodiment, buffer agent 106 may communicate to posted write buffer 110 the buffer location to be used to store the data. In another embodiment, buffer agent 106 and posted write buffer 110 may utilize a shared algorithm to determine which buffer location will be used to store data without requiring the location to be communicated.

As used herein control logic 202 provides the logical interface between buffer agent 106 and its host electronic appliance 100. In this regard, control logic 202 may manage one or more aspects of buffer agent 106 to provide a communication interface to electronic appliance 100, e.g., through memory controller 104. Control logic 202 may also enable buffer agent 106 to determine if can be written (retired) to a particular memory address or whether a read transaction is temporarily blocking the ability to write to certain memory devices.

According to one aspect of the present invention, though the claims are not so limited, control logic 202 may selectively invoke the resource(s) of buffer engine 208. As part of an example method for posted write buffering, as explained in greater detail with reference to FIG. 3, control logic 202 may selectively invoke data services 210 that may send data to a posted write buffer. Control logic 202 also may selectively invoke table services 212 or retire services 214, as explained in greater detail with reference to FIG. 3, to maintain a table of the data in the posted write buffer or to retire data from the posted write buffer to a memory address, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store a table to represent the data stored in posted write buffer 110, for example.

Controller interface 206 provides a path through which buffer agent 106 can communicate with memory controller 104. Buffer agent 106 utilizes this interface to receive data to be written to memory and to send data and commands along write interface 112 to system memory 108.

As introduced above, buffer engine 208 may be selectively invoked by control logic 202 to send data to a posted write buffer, to maintain a table of the data in the posted write buffer, or to retire data from the posted write buffer to a memory address. In accordance with the illustrated example implementation of FIG. 2, buffer engine 208 is depicted comprising one or more of data services 210, table services 212 and retire services 214. Although depicted as a number of disparate elements, those skilled in the art will appreciate that one or more elements 210-214 of buffer engine 208 may well be combined without deviating from the scope and spirit of the present invention.

Data services 210, as introduced above, may provide buffer agent 106 with the ability to send data to a posted write buffer. In one example embodiment, data services 210 may send the address to which the data will ultimately be retired along with the data to be stored temporarily in posted write buffer 110. In another embodiment, a data frame sent to posted write buffer 110 may include a bit vector to indicate the buffer entry in which to store the data. Alternatively, the bit vector can be left out if there is a shared algorithm by which table services 212 and posted write buffer 110 know beforehand the buffer entry in which the data will be stored. The data frame could include a byte of data or a series of bytes so as to match the entry size of posted write buffer 110 or the write protocol for system memory 108.

As introduced above, table services 212 may provide buffer agent 106 with the ability to maintain a table of the data in the posted write buffer. In one example embodiment, table services 212 may maintain a table in memory 204 that contains the same data as posted write buffer 110. In another embodiment, the table maintained in memory 204 may contain a subset of the data stored in posted write buffer 110 or may contain the memory addresses associated with the data indexed in posted write buffer 110. Table services 212 may share an algorithm with posted write buffer 110 to determine in which buffer entry a particular set of data will be stored. In one embodiment, both table services 212 and posted write buffer 110 know the size of posted write buffer 110, the buffer entry in which to store the first set of data after a reset, and the method for selecting subsequent buffer entries. An example method for selecting subsequent buffer entries would be to utilize the first unused entry.

Retire services 214, as introduced above, may provide buffer agent 106 with the ability to retire data from the posted write buffer to a memory address. In one embodiment, retire services 214 may send a column access strobe (CAS) command to a memory address of system memory 108 along with a bit vector corresponding to the data entry in posted write buffer 110 that is to be retired. In another embodiment, retire services 214 may send only the bit vector corresponding to the data entry in posted write buffer 110 that is to be retired, where posted write buffer 110 contains the memory address to which the data is to be retired.

FIG. 3 is a flow chart of an example method for posted write buffering, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, method 300 begins with data services 210 being invoked to send (302) memory write data to posted write buffer 110. In one example embodiment, the data could be received from network controller 118. In another embodiment, the data could be provided by processor 102.

Next, buffer agent 106 may invoke table services 212 to create (304) a table entry. In one example embodiment, table services 212 tracks the data sent to posted write buffer 110 and the addresses to which the data will be written.

Next, control logic 202 may decide (306) whether data in the posted write buffer can be retired. In one embodiment, a read transaction from a particular memory bank would prevent a write to that memory bank from occurring simultaneously. Based on the address to which the data will be written, control logic 202 may determine whether the data can be retired.

If the data can not be retired, control logic 202 may selectively invoke send services 210 or retire services 214 to send (308) or retire other data, respectively. In one example embodiment, send services 210 is selectively invoked to send other data to be temporarily stored in posted write buffer 110 if there is no other data that can be retired. In another embodiment, retire services 214 is selectively invoked to retire other data stored in posted write buffer 110 if there are no unused buffer entries.

If the data can be retired, control logic 202 may selectively invoke retire services 214 and table services 212 to retire (310) data and update table entries, respectively. In one embodiment, retire services 214 includes a bit vector corresponding to the data in posted write buffer 110 to be retired as part of a CAS frame that prepares the appropriate memory device to store the data. Table services 212 may clear the entry associated with the data retired so that it may be reused.

FIG. 4 illustrates a block diagram of an example storage medium comprising content which, when accessed by a device, causes the device to implement one or more embodiment(s) of the invention, for example buffer agent 106 and/or associated method 300. In this regard, storage medium 400 includes content 402 (e.g., instructions, data, or any combination thereof) which, when executed, causes the appliance to implement one or more aspects of buffer agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
receiving data to be written to memory;
storing the data in a write buffer; and
receiving an independent indication to write the data to a memory address.

2. The method of claim 1, further comprising:
writing the data to the memory address out-of-order from receiving the data.

3. The method of claim 1, further comprising:
receiving the data over a unidirectional bus.

4. The method of claim 1, further comprising:
receiving a buffer index in which to store the data.

5. The method of claim 1, wherein storing the data in a buffer comprises:
storing the data in a predetermined buffer index.

6. The method of claim 1, wherein receiving an indication to write the data to a memory address comprises:
receiving a column access strobe (CAS) command with the buffer location of the data to be written to memory.

7. An electronic appliance, comprising:
a processor to process data;
a memory to store data;
a network controller to communicate data; and
a buffer engine coupled with the network controller, the memory and the processor, the buffer engine to send data to the memory and to send an independent indication to the memory to write the data to an address.

8. The electronic appliance of claim 7, further comprising:
the buffer engine to maintain a table to track data stored in a write buffer of the memory.

9. The electronic appliance of claim 7, further comprising:
the buffer engine to send a bit vector to indicate which data entry in a buffer to retire to memory.

10. The electronic appliance of claim 7, further comprising:
the buffer engine to determine a buffer entry that will be used by the memory to temporarily store the data.

11. A storage medium comprising content which, when executed by an accessing machine, causes the accessing machine to send data to a posted write buffer in a memory device and to send an independent indication to retire the data to memory.

12. The storage medium of claim 11, further comprising content which, when executed by the accessing machine, causes the accessing machine to determine a buffer entry that will be used by the memory device to temporarily store the data based on a shared algorithm.

13. The storage medium of claim 11, further comprising content which, when executed by the accessing machine, causes the accessing machine to retire data from the posted write buffer out of the order in which the data was sent.

14. The storage medium of claim 11, further comprising content which, when executed by the accessing machine, causes the accessing machine to read data from the memory device before retiring buffered data to the memory device.

15. The storage medium of claim 11, wherein the content to send an independent indication to retire the data to memory comprises content which, when executed by the accessing machine, causes the accessing machine to send a column access strobe (CAS) command with the buffer index of the data to be retired to memory.

16. An apparatus, comprising:
a processor interface;
unidirectional memory write and read interfaces; and
control logic coupled with the processor and unidirectional memory write and read interfaces, the control logic to send data out the memory write interface to be temporarily stored in a buffer and to send an independent indication out the memory write interface to write the data to a memory address.

17. The apparatus of claim 16, further comprising control logic to maintain a table to track data sent out the memory write interface based on an algorithm shared with a memory device.

18. The apparatus of claim 16, further comprising control logic to substantially expedite memory reads over the memory read interface by retiring data to memory that does not conflict with read activity.

19. The apparatus of claim 16, further comprising control logic to send column access strobe (CAS) commands out the memory write interface including a buffer index of the data to be retired to the memory address.

20. An apparatus, comprising:
a memory device;
two unidirectional interfaces;
a buffer; and
control logic coupled with the memory device, unidirectional interfaces and buffer, the control logic to temporarily store received data in the buffer and to write the data to the memory device in response to an independent indication received.

21. The apparatus of claim 20, further comprising control logic to determine a buffer index to be used to temporarily store the data based on an algorithm shared with a memory controller.

22. The apparatus of claim 20, further comprising control logic to retire data from the buffer to the memory device out of the order in which the data was received.
